(19) United States
(12) Patent Application Publication
(10) Pub. No.: US 2024/0305092 A1
(43) Pub. Date: Sep. 12, 2024

(54) POWER SUPPLY DEVICE

(71) Applicant: ISUZU MOTORS LIMITED, Yokohama-shi (JP)

(72) Inventors: Ryoma NISHIMURA, Fujisawa-shi (JP); Ryo FUKUDA, Fujisawa-shi (JP)

(21) Appl. No.: 18/588,049

(22) Filed: Feb. 27, 2024

(30) Foreign Application Priority Data
Mar. 7, 2023 (JP) 2023-034771

(51) Int. Cl. H02J 1/08; B60R 16/033

(52) U.S. Cl. CPC H02J 1/086; B60R 16/033

(57) ABSTRACT

A power supply apparatus includes an output terminal that supplies electric power, supplied from at least any of a plurality of power storage devices installed in a vehicle, to at least any of the plurality of pieces of equipment, and a switching part that switches whether respective connection terminals of the plurality of power storage devices are i) connected to one or more of connection terminals of other power storage devices among the plurality of power storage devices, ii) connected to the output terminals, or iii) not connected to any of terminals of the other power storage devices and the output terminals, and a switching controller that controls the switching part to cause the output terminal to output electric power supplied from at least any of the plurality of power storage devices.

### CROSS-REFERENCE TO RELATED APPLICATIONS

The present application claims priority to Japanese Patent Application number 2023-034771, filed on Mar. 7, 2023, contents of which are incorporated herein by reference in its entirety.

### BACKGROUND OF THE INVENTION

The present disclosure relates to a power supply apparatus.

Japanese Unexamined Patent Application Publication No. 2015-070627 discloses a power supply apparatus for supplying electric power from a plurality of power storage devices to equipment installed in a vehicle, the vehicle being an electric vehicle using a motor as a power source or a hybrid vehicle using a motor and an engine as power sources.

A conventional power supply apparatus has a problem that electric power cannot be supplied to equipment installed in a vehicle if any of a plurality of power storage devices fail.

### BRIEF SUMMARY OF THE INVENTION

The present disclosure focuses on this point, and an object thereof is to enable electric power to be supplied to equipment installed in a vehicle even if any of a plurality of power storage devices fail.

### Means for Solving the Problems

A power supply apparatus according to a first aspect of the present disclosure is a power supply apparatus for supplying electric power to at least any of a plurality of pieces of equipment installed in a vehicle, the apparatus includes an output terminal that supplies electric power, supplied from at least any of a plurality of power storage devices installed in the vehicle, to at least any of the plurality of pieces of equipment, and a switching part that switches whether respective connection terminals of the plurality of power storage devices are i) connected to one or more of connection terminals of other power storage devices among the plurality of power storage devices, ii) connected to the output terminals, or iii) not connected to any of terminals of the other power storage devices and the output terminals, and a switching controller that controls the switching part to cause the output terminal to output electric power supplied from at least any of the plurality of power storage devices.

### BRIEF DESCRIPTION OF THE DRAWINGS

FIG. 1 illustrates an overview of a power supply apparatus according to the first embodiment.

FIG. 2 shows a functional configuration of a switching control device according to the first embodiment.

FIG. 3 shows an example of connection management information according to the first embodiment.

FIG. 4 shows a functional configuration of the switching control device according to the second embodiment.

FIG. 5 shows an example of the connection management information according to the second embodiment.

FIG. 6 shows a functional configuration of the switching control device according to the third embodiment.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### First Embodiment

[Overview of power supply apparatus 1]

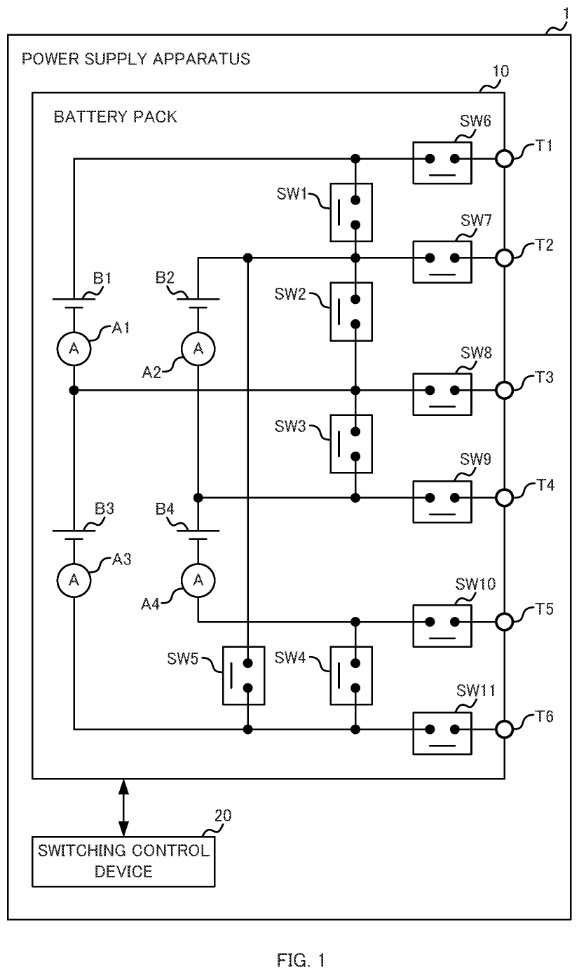

FIG. 1 illustrates an overview of a power supply apparatus 1 according to the first embodiment. The power supply apparatus 1 according to the embodiment is installed in a vehicle such as an electric vehicle or a hybrid vehicle which uses a motor as a driving force to travel. The power supply apparatus 1 is used to supply electric power, from at least any of a plurality of power storage devices installed in a vehicle, to at least any of a plurality of pieces of onboard equipment including a traveling motor, a crane, a refrigerator, or the like installed in the vehicle. The power supply apparatus 1 according to the embodiment is suitable for a large-sized electric vehicle such as a bus or a truck, but the present disclosure is not limited thereto. The present embodiment will be described on the assumption that the vehicle is an electric vehicle such as a bus or a truck in the following.

The power supply apparatus 1 according to the embodiment includes, for example, i) a battery pack 10 for accommodating power storage devices and ii) a switching control device 20. The battery pack 10 includes a plurality of power storage devices B1 to B4, a plurality of ammeters A1 to A4, a plurality of output terminals T1 to T6, and switches SW1 to SW11 as a plurality of switching parts.

The power storage devices B1 to B4 are battery modules, for example. The power storage devices B1 to B4 supply the electric power to at least any of the plurality of pieces of onboard equipment installed in the vehicle. As shown in FIG. 1, a positive terminal of the power storage device B1 is connected to the switches SW1 and SW6. A negative terminal of the power storage device B1 is connected to the switches SW2, SW3, and SW8 and the positive terminal of the power storage device B3, via the ammeter A1. A positive terminal of the power storage device B2 is connected to the switches SW1, SW2, SW5, and SW7. A negative terminal of the power storage device B2 is connected to the switches SW3 and SW9 and the positive terminal of the power storage device B4, via the ammeter A2.

A positive terminal of the power storage device B3 is connected to the switches SW2, SW3, and SW8 and the negative terminal of the power storage device B1. A negative terminal of the power storage device B3 is connected to the switches SW4, SW5, and SW11 via the ammeter A3. A positive terminal of the power storage device B4 is connected to the switches SW3 and SW9 and the negative terminal of the power storage device B2. A negative terminal of the power storage device B4 is connected to the switches SW4 and SW10 via the ammeter A4.

The plurality of ammeters A1 to A4 detect currents outputted respectively from the plurality of power storage devices B1 to B4. As shown in FIG. 1, the ammeter A1 measures the current flowing through a line connected to the negative terminal of the power storage device B1. Similarly, the ammeters A2, A3, and A4 respectively measure the currents flowing through lines connected to the negative terminals of the power storage devices B2, B3, and B4. Each of the plurality of ammeters A1 to A4 outputs current information indicating the measured current to the switching control device 20.

The switches SW1 to SW11 are, for example, semiconductor relay circuits or mechanical relay circuits. The switches SW1 to SW11 are used by a controller 22 to switch whether respective connection terminals of the plurality of power storage devices B1 to B4 are i) connected to one or more of the connection terminals of other power storage devices among the plurality of power storage devices B1 to B4, ii) connected to the plurality of output terminals, or iii) not connected to any of the terminals of the other power storage devices and the output terminals.

One end of the switch SW1 is connected to the switch SW6 and the positive terminal of the power storage device B1. The other end of the switch SW1 is connected to the switches SW2, SW5, and SW7 and the positive terminal of the power storage device B2. One end of the switch SW2 is connected to the switches SW1, SW5, and SW7 and the positive terminal of the power storage device B2. The other end of the switch SW2 is connected to the switches SW3 and SW8, the negative terminal of the power storage device B1, and the positive terminal of the power storage device B3.

One end of the switch SW3 is connected to the switches SW2 and SW8, the negative terminal of the power storage device B1, and the positive terminal of the power storage device B3. The other end of the switch SW3 is connected to the switch SW9, the negative terminal of the power storage device B2, and the positive terminal of the power storage device B4. One end of the switch SW4 is connected to the switch SW10 and the negative terminal of the power storage device B4. The other end of the switch SW4 is connected to the switches SW5 and SW11 and the negative terminal of the power storage device B3. One end of the switch SW5 is connected to the switches SW1, SW2, and SW7 and the positive terminal of the power storage device B2. The other end of the switch SW5 is connected to the switches SW4 and SW11 and the negative terminal of the power storage device B3.

One end of the switch SW6 is connected to the switch SW1 and the positive terminal of the power storage device B1. The other end of the switch SW6 is connected to the output terminal T1. One end of the switch SW7 is connected to the switches SW1, SW2, and SW5 and the positive terminal of the power storage device B2. The other end of the switch SW7 is connected to the output terminal T2. One end of the switch SW8 is connected to the switches SW2 and SW3, the negative terminal of the power storage device B1, and the positive terminal of the power storage device B3. The other end of the switch SW8 is connected to the output terminal T3.

One end of the switch SW9 is connected to the switch SW3, the negative terminal of the power storage device B2, and the positive terminal of the power storage device B4. The other end of the switch SW9 is connected to the output terminal T4. One end of the switch SW10 is connected to the switch SW4 and the negative terminal of the power storage device B4. The other end of the switch SW10 is connected to the output terminal T5. One end of the switch SW11 is connected to the switches SW4 and SW5 and the negative terminal of the power storage device B3. The other end of the switch SW11 is connected to the output terminal T6.

The plurality of output terminals T1 to T6 are used to supply the electric power, supplied from at least any of the plurality of power storage devices B1 to B4 installed in the vehicle, to at least any of the plurality of pieces of equipment. The plurality of output terminals T1 to T6 supply the electric power through one or more systems in accordance with the states of the switches SW1 to SW11.

The switching control device 20 is, for example, a battery ECU installed in the vehicle. The switching control device 20 switches the switches SW1 to SW11 in the battery pack 10 between an ON state and an OFF state. The switching control device 20 controls the switches SW1 to SW11 to cause at least any of the output terminals T1 to T6 to output the electric power, supplied from at least any of the plurality of power storage devices B1 to B4. In this way, even if any of the plurality of power storage devices B1 to B4 fail, the power supply apparatus 1 can switch to supply the electric power from a power storage device that is not in failure. Therefore, the power supply apparatus 1 can continuously supply the electric power to the equipment installed in the vehicle.

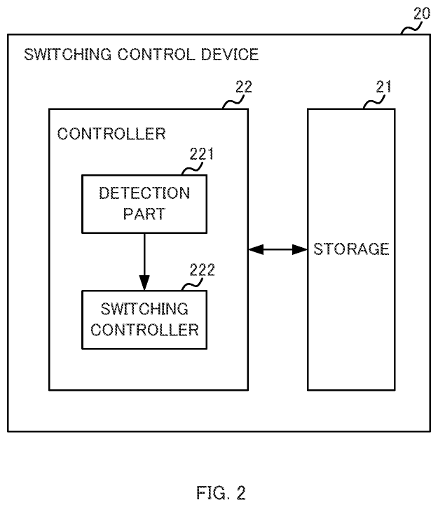

Next, a configuration of the switching control device 20 will be described. FIG. 2 shows a functional configuration of the switching control device 20 according to the first embodiment. As shown in FIG. 2, the switching control device 20 includes a storage 21 and the controller 22. The storage 21 is, for example, a Random Access Memory (RAM) or a Read Only Memory (ROM). The storage 21 stores a program that causes the controller 22 to function as a detection part 221 and a switching controller 222.

The controller 22 is a processor such as a Central Processing Unit (CPU). The controller 22 functions as the detection part 221 and the switching controller 222 by executing the program stored in the storage 21.

The detection part 221 detects a failed power storage device from among the plurality of power storage devices B1 to B4. For example, the detection part 221 detects a failed power storage device among the plurality of power storage devices B1 to B4 on the basis of the currents of the plurality of power storage devices B1 to B4 measured by the plurality of ammeters A1 to A4. It should be noted that the detection part 221 is assumed to detect a failed power storage device on the basis of the current measured by each of the ammeters A1 to A4, but the present disclosure is not limited thereto. The detection part 221 may detect a failed power storage device using another method. In this case, the battery pack 10 may be provided with a voltmeter for measuring voltage of each of the plurality of power storage devices B1 to B4. The detection part 221 may then detect a failed power storage device among the plurality of power storage devices B1 to B4 on the basis of the voltage of each of the plurality of power storage devices B1 to B4 measured by the voltmeter.

The switching controller 222 controls the switches SW1 to SW11 to cause at least two output terminals of the output terminals T1 to T6 to output the electric power supplied from at least any of the plurality of power storage devices B1 to B4. The switching controller 222 controls the switches SW1 to SW11 to cause the output terminal to output the electric power at any of a plurality of output voltages set in advance.

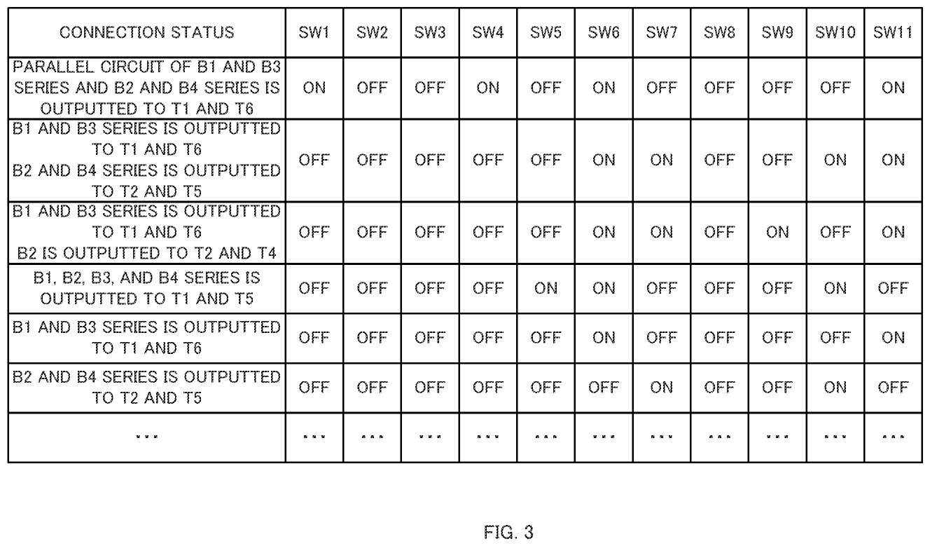

For example, the storage 21 stores connection management information that associates i) connection status information indicating a connection status of the respective connection terminals of the plurality of power storage devices B1 to B4 to one or more of the connection terminals of other power storage devices or the output terminals T1 to T6 and ii) combination information indicating a combination of states of the switches SW1 to SW11. FIG. 3 shows an example of the connection management information according to the first embodiment. In the example shown in FIG. 3, i) the connection statuses of the plurality of power storage devices B1 to B4 and ii) which of the output terminals T1 to T6 outputs the electric power are shown as the connection status information. Respective ends of a switch are electrically connected if the switch is ON, and the respective ends of the switch are not electrically connected if the switch is OFF.

The switching controller 222 controls the states of the switches SW1 to SW11 in accordance with the combination of the states of the switches SW1 to SW11 indicated by the combination information stored in the storage 21, thereby causing at least two output terminals of the output terminals T1 to T6 to output the electric power supplied from at least any of the plurality of power storage devices B1 to B4.

For example, when a series connection of the power storage device B1 and the power storage device B3 and a series connection of the power storage device B2 and the power storage device B4 are connected in parallel to output the electric power, the switching controller 222 turns ON the switches SW1, SW4, SW6, and SW11 and turns OFF other switches according to the combination information. This results in one system of power output, with the output terminal T1 being a positive terminal and the output terminal T6 being a negative terminal.

Further, when the series connection of the power storage device B1 and the power storage device B3 and the series connection of the power storage device B2 and the power storage device B4 separately output the electric power as different systems, the switching controller 222 turns ON the switches SW6, SW7, SW10, and SW11 and turns OFF other switches according to the combination information. This results in a first system of power output with the output terminal T1 as a positive terminal and the output terminal T6 as a negative terminal, and a second system of power output with the output terminal T2 as a positive terminal and the output terminal T5 as a negative terminal.

Furthermore, the switching controller 222 controls the switches SW1 to SW11 so that a power storage device whose failure has been detected by the detection part 221 is connected neither to the connection terminal of the other power storage device among the plurality of power storage devices B1 to B4 nor to the output terminal. For example, it is assumed that the switches SW1, SW4, SW6, and SW11 are turned ON and other switches are turned OFF, and the series connection of the power storage device B1 and the power storage device B3 and the series connection of the power storage device B2 and the power storage device B4 are connected in parallel to output the electric power. In this state, if the detection part 221 detects a failure in the power storage device B2, the switching controller 222 performs control to switch the switches SW1 and SW4 to the OFF state to cause a circuit connecting the power storage devices B1 and B3 in series to output the electric power. As a result, the switching controller 222 can prevent a failed power storage device from being connected to the connection terminal of the other storage device and the output terminal without changing the output voltage and the output terminal, and can continue supplying the electric power to the equipment installed in the vehicle without voltage fluctuation or the like.

### Effects According to the First Embodiment

As described above, the power supply apparatus 1 according to the first embodiment includes the output terminals T1 to T6 and the switches SW1 to SW11. The output terminals T1 to T6 are used to supply the electric power, supplied from at least any of the plurality of power storage devices B1 to B4 installed in the vehicle, to at least any of the plurality of pieces of equipment. The switches SW1 to SW11 switch whether the respective connection terminals of the plurality of power storage devices B1 to B4 are i) connected to one or more of the connection terminals of other power storage devices among the plurality of power storage devices B1 to B4, ii) connected to the output terminals, or iii) not connected to any of the terminals of the other power storage devices and the output terminals. The power supply apparatus 1 then controls the switches SW1 to SW11 to cause at least two output terminals among the output terminals T1 to T6 to output the electric power supplied from at least any of the plurality of power storage devices B1 to B4. In this way, the power supply apparatus 1 can continue to supply the electric power to the equipment installed in the vehicle even if any of the plurality of power storage devices fail.

### Second Embodiment

Next, the second embodiment will be described. For example, when the electric power is supplied by at least any of the plurality of power storage devices B1 to B4 to the traveling motor, the amount of electric power supplied from the power storage devices B1 to B4 to the traveling motor varies greatly depending on a traveling status of the vehicle. To address this, it is necessary to supply the electric power in accordance with the traveling status. Therefore, the power supply apparatus 1 according to the second embodiment identifies an operation status of the vehicle and controls the switches SW1 to SW11 on the basis of the identified operation status. The power supply apparatus 1 according to the second embodiment will be described below. It should be noted that the description of the same parts as in the first embodiment will be omitted as appropriate.

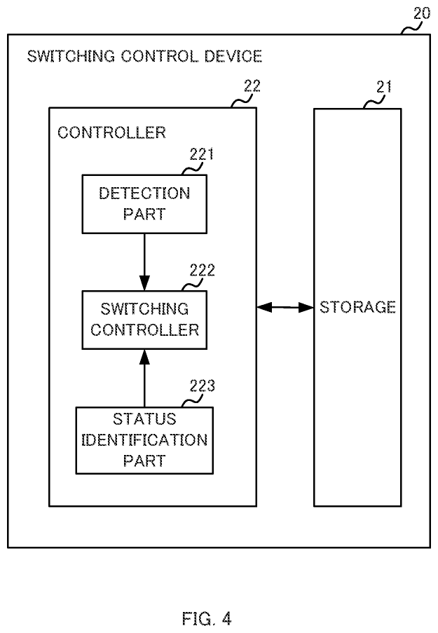

FIG. 4 shows a functional configuration of the switching control device 20 according to the second embodiment. As shown in FIG. 4, the controller 22 of the switching control device 20 according to the second embodiment further includes a status identification part 223.

The status identification part 223 identifies the operation status of the vehicle. For example, the status identification part 223 identifies, as the operation status of the vehicle, the traveling status of the vehicle on the basis of the current measured by the ammeter corresponding to the power storage device that supplies the electric power to the traveling motor. For example, the status identification part 223 identifies, as the traveling status of the vehicle, whether the vehicle is traveling (small load), traveling (large load), or stopped. Further, the status identification part 223 identifies the operation status of equipment different from the traveling motor, which is the equipment to which the electric power is supplied from the traveling motor.

The switching controller 222 controls the switches SW1 to SW11 so that the electric power at an output voltage corresponding to the operation status of the vehicle identified by the status identification part 223 is outputted from at least two of the output terminals T1 to T6. In this case, the storage 21 stores in advance the connection management information that associates i) the operation status of the vehicle, ii) the connection status information indicating the connection status of the respective connection terminals of the plurality of power storage devices B1 to B4 corresponding to the operation status to the connection terminals of the other power storage devices or the output terminals T1 to T6, and iii) the combination information indicating the combination of the states of the switches SW1 to SW11.

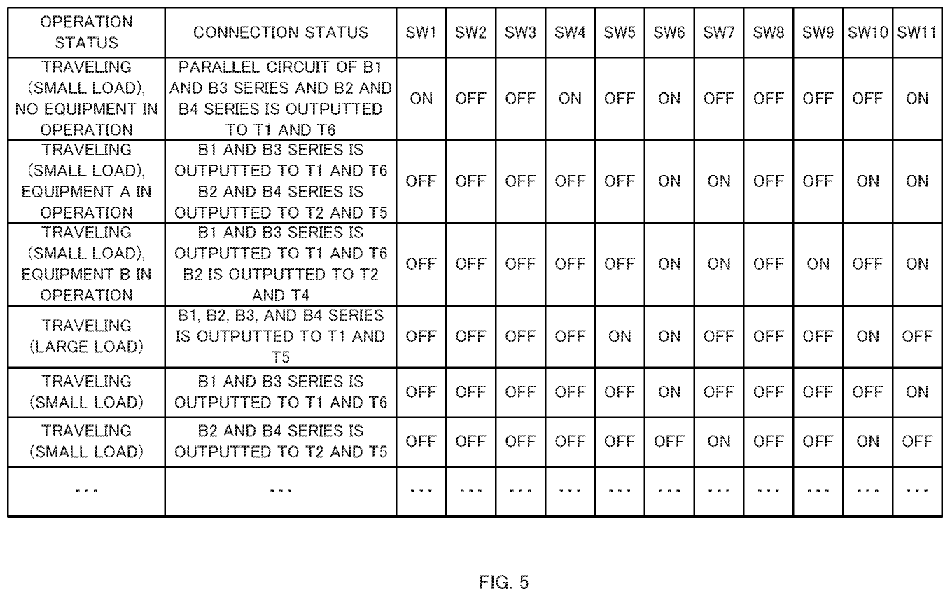

FIG. 5 shows an example of the connection management information according to the second embodiment. In FIG. 5, it can be confirmed that the connection status information indicating the connection status of the respective connection terminals of the plurality of power storage devices B1 to B4 to the connection terminals of the other power storage devices or the output terminals T1 to T6 and the combination information of the switches SW1 to SW11 are associated with the operation status of the vehicle.

The switching controller 222 references the connection management information stored in the storage 21, and identifies the connection status associated with the operation status of the vehicle identified by the status identification part 223. The switching controller 222 controls the states of the switches SW1 to SW11 on the basis of the combination information corresponding to the information indicating the identified connection status. In this manner, the power supply apparatus 1 can switch the connection status of the respective connection terminals of the plurality of power storage devices B1 to B4 to the connection terminals of the other power storage devices or the output terminals T1 to T6 to an appropriate status according to the operation status of the vehicle, and can supply the electric power suitable for the operation status.

### Third Embodiment

Next, the third embodiment will be described. When the electric power is outputted from at least any of a plurality of power storage devices, it may be possible to output the electric power at the same voltage and current in a plurality of connection statuses. If remaining capacities of the plurality of power storage devices are different from each other, it is preferable that the plurality of power storage devices are discharged in a balanced manner so that a difference in frequency of use of the power storage devices is suppressed and hastening of deterioration of some of the power storage devices is prevented. To address this, the third embodiment differs from the second embodiment in that one connection status is selected from among said plurality of connection statuses on the basis of the remaining capacities of the plurality of power storage devices, and the switches SW1 to SW11 are controlled on the basis of the selected connection status.

The power supply apparatus 1 according to the third embodiment will be described below. It should be noted that, in the third embodiment, it is assumed that the connection management information in the storage 21 stores the operation status of one vehicle and one or more connection statuses in association with each other.

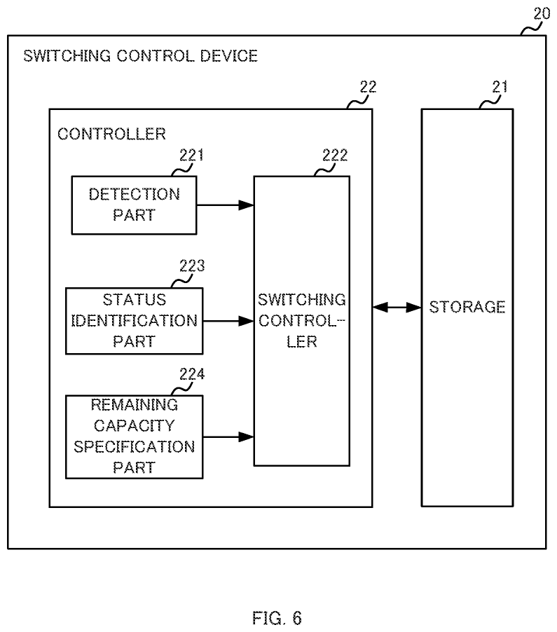

FIG. 6 shows a functional configuration of the switching control device 20 according to the third embodiment. As shown in FIG. 6, the controller 22 of the switching control device 20 according to the third embodiment further includes a remaining capacity specification part 224.

The remaining capacity specification part 224 specifies the remaining capacity of each of the plurality of power storage devices B1 to B4. Each of the plurality of power storage devices B1 to B4 may include a notification part that provides remaining capacity information indicating its remaining capacity. The remaining y specification part 224 specifies the remaining capacity of each of the plurality of power storage devices B1 to B4 by obtaining the remaining capacity information from each of the plurality of power storage devices B1 to B4.

If a plurality of connection statuses are associated with the operation status of the vehicle identified by the status identification part 223 in the connection management information stored in the storage 21, the switching controller 222 selects one connection status from among the plurality of connection statuses on the basis of the remaining capacities specified by the remaining capacity specification part 224.

Specifically, if the plurality of connection statuses are associated with the operation status of the vehicle identified by the status identification part 223, the switching controller 222 selects a connection status in which the electric power is supplied from the power storage device having a relatively large remaining capacity among the plurality of connection statuses. The switching controller 222 then controls the switches SW1 to SW11 on the basis of the combination information of the switches SW1 to SW11 associated with the selected connection status. In this manner, the power supply apparatus 1 can cause the plurality of power storage devices B1 to B4 to be discharged in a balanced manner and suppress the difference in the frequency of use of the plurality of power storage devices B1 to B4. As a result, the power supply apparatus 1 can prevent hastening of the deterioration of some of the power storage devices.

The present disclosure is explained on the basis of the exemplary embodiments. The technical scope of the present disclosure is not limited to the scope explained in the above embodiments and it is possible to make various changes and modifications within the scope of the disclosure. For example, the above-mentioned embodiment describes an example where four power storage devices are provided in the battery pack 10, but the present disclosure is not limited thereto. Five or more power storage devices may be provided in the battery pack 10. In this case, the battery pack 10 may be provided with a switch capable of switching the respective connection terminals of the five or more power storage devices to be i) connected to one or more of the connection terminals of other power storage devices among these power storage devices, ii) connected to the output terminals, and iii) not connected to any of the terminals of the other power storage devices and the output terminals, and the switching controller 222 may control these switches to cause the output terminals to output the electric power supplied from at least any of the power storage devices.

1. A power supply apparatus for supplying electric power to at least any of a plurality of pieces of equipment installed in a vehicle, the apparatus comprising:
an output terminal that supplies electric power, supplied from at least any of a plurality of power storage devices installed in the vehicle, to at least any of the plurality of pieces of equipment; and
a switching part that switches whether respective connection terminals of the plurality of power storage devices are i) connected to one or more of connection terminals of other power storage devices among the plurality of power storage devices, ii) connected to the output terminals, or iii) not connected to any of terminals of the other power storage devices and the output terminals; and
a switching controller that controls the switching part to cause the output terminal to output electric power supplied from at least any of the plurality of power storage devices.

2. The power supply apparatus according to claim 1, further comprising:
a detection part that detects a failed power storage device from among the plurality of power storage devices, wherein the switching controller controls the switching part so that a power storage device whose failure is detected by the detection part is connected neither to the connection terminal of the other power storage device among the plurality of power storage devices nor to the output terminal.

3. The power supply apparatus according to claim 1, wherein
the switching controller controls the switching part to cause the output terminal to output electric power at any of a plurality of output voltages set in advance.

4. The power supply apparatus according to claim 1, wherein
the switching controller controls the switching part to control whether at least two power storage devices of the plurality of power storage devices are connected in series or in parallel.

5. The power supply apparatus according to claim 1, wherein
the switching controller controls the switching part to control whether electric power to be outputted from at least two power storage devices among the plurality of power storage devices is outputted as electric power from one system or two systems.

6. The power supply apparatus according to claim 3, further comprising:
a storage that stores connection management information that associates i) connection status information, corresponding to each of the plurality of output voltages, indicating statuses of connections of respective connection terminals of the plurality of power storage devices to one or more of connection terminals of other power storage devices or the output terminals and ii) combination information indicating a combination of states of the switching part, wherein
the switching controller controls a state of the switching part in accordance with a combination of states of the switching part indicated by the combination information stored in the storage in association with a connection status corresponding to any of the plurality of output voltages to cause at least two output terminals of the output terminals to output electric power supplied from at least any of the plurality of power storage devices.

7. The power supply apparatus according to claim 3, further comprising:
a status identification part that identifies an operation status of the vehicle, wherein
the switching controller controls the switching part such that electric power at an output voltage corresponding to the operation status of the vehicle identified by the status identification part is outputted from the output terminal.

8. The power supply apparatus according to claim 7, wherein the plurality of power storage devices can supply electric power to a traveling motor of the vehicle,
the status identification part identifies a traveling status of the vehicle as an operation status of the vehicle, and
the switching controller controls the switching part such that electric power at an output voltage corresponding to the traveling status identified by the status identification part is outputted from the output terminal.

9. The power supply apparatus according to claim 8, wherein
the status identification part identifies, as the operation status, an operation status of onboard equipment to which the traveling motor supplies electric power, and
the switching controller controls the switching part such that electric power at an output voltage corresponding to the traveling status identified by the status identification part and the operation status is outputted from the output terminal.

10. The power supply apparatus according to claim 1, further comprising:
a status identification part that identifies an operation status of the vehicle; and
a storage that stores i) an operation status of the vehicle and ii) information indicating statuses of connections of respective connection terminals of the plurality of power storage devices corresponding to the operation status to the connection terminal of the other power storage devices or the output terminals in association with each other, wherein the switching controller references the storage,
identifies the connection status associated with the operation status identified by the status identification part, and controls the switching part on the basis of information indicating the identified connection status.

11. The power supply apparatus according to claim 10, wherein
the storage stores an operation status of one vehicle and one or more connection statuses in association with each other,
the power supply apparatus further comprises a remaining capacity specification part that specifies a remaining capacity of each of the plurality of power storage devices, and
if a plurality of connection statuses are associated with the operation status identified by the status identification part in the storage, the switching controller selects one connection status from among the plurality of connection statuses on the basis of the remaining capacity specified by the remaining capacity specification part, and controls the switching part on the basis of the selected connection status.

12. The power supply apparatus according to claim 11, wherein
if a plurality of connection statuses are associated with the operation status identified by the status identification part, the switching controller selects a connection status in which electric power is supplied from the power storage device having a relatively large remaining capacity, among the plurality of connection statuses.
